(19) United States
(12) Patent Application Publication
(10) Pub. No.: US 2020/0213987 A1
(43) Pub. Date: Jul. 2, 2020

(54) BEAM SPECIFIC SCRAMBLING OF REFERENCE AND DATA SIGNALS

(71) Applicant: QUALCOMM Incorporated, San Diego, CA (US)

(72) Inventors: Kiran VENUGOPAL, Raritan, NJ (US); Tianyang Bai, Bridgewater, NJ (US); Jung Ryu, Fort Lee, NJ (US); Makesh Pravin John Wilson, San Diego, CA (US); Tao Luo, San Diego, CA (US)

(21) Appl. No.: 16/455,092

(22) Filed: Jun. 27, 2019

Related U.S. Application Data
(60) Provisional application No. 62/785,521, filed on Dec. 27, 2018.

(51) Int. Cl. H04W 72/04; H04B 17/309; H04W 72/02

(52) U.S. Cl. CPC H04W 72/046; H04W 72/02; H04B 17/309

(57) ABSTRACT

Aspects of beam specific scrambling of reference and data signals are disclosed. In an example, a user equipment (UE) receives a plurality of beams from a base station and determines payloads of a first control signal of a first beam of the plurality of beams and a second control signal of a second beam of the plurality of beams are a same payload. The UE also compares signal quality characteristics of the first control signal the second control signal when the payloads are the same payload and selects a better quality beam from the first beam and the second beam for decoding a data signal of the better quality beam in response to the comparison. The UE also decodes the data signal of the better quality beam.

### CROSS-REFERENCE TO RELATED APPLICATION(S)

This application claims the benefit of U.S. Provisional Application Ser. No. 62/785,521, entitled “BEAM SPECIFIC SCRAMBLING OF REFERENCE AND DATA SIGNALS” and filed on Dec. 27, 2018, which is expressly incorporated by reference herein in its entirety.

### BACKGROUND

The present disclosure relates generally to communication systems, and more particularly, to beam specific scrambling of reference and data signals.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is fifth generation (5G) New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR include services associated with enhanced mobile broadband (eMBB), massive machine type communications (mMTC), and ultra reliable low latency communications (URLLC). Some aspects of 5G NR may be based on the 4G Long Term Evolution (LTE) standard.

5G NR technologies may include millimeter wave (mmWave) transmissions via beams that are susceptible to blockages. The mmWave signals may be transmitted over multiple beams to provide macro diversity for communications. Multiple beam transmissions may produce reference and data signal mismatch. Accordingly, there exists a need for further improvements in 5G NR technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. The sole purpose of this summary is to present some concepts of one or more aspects in a simplified form as a prelude to the more detailed description that is presented later.

In an aspect of the disclosure, a method for wireless communications by a user equipment (UE) is described. The method may include receiving a plurality of beams from a base station The method may also include determining payloads of a first control signal of a first beam of the plurality of beams and a second control signal of a second beam of the plurality of beams are a same payload. The method may further include comparing signal quality characteristics of the first control signal and the second control signal in response to the determining the payloads are the same payload. The method may include selecting a better quality beam from the first beam and the second beam for decoding data signals based on the comparing of the signal quality characteristics, and decoding a data signal of the bet.

In an aspect, an apparatus for wireless communication is disclosed. The apparatus may include a memory storing instructions and at least one processor coupled with the memory. The at least one processor may be configured to execute the instructions to receive a plurality of beams from a base station. The at least one processor may also be configured to execute the instructions to determine payloads of a first control signal of a first beam of the plurality of beams and a second control signal of a second beam of the plurality of beams are a same payload. The at least one processor may be configured to execute the instructions to compare signal quality characteristics of the first control signal and the second control signal in response to the determining the payloads are the same payload. The at least one processor may also be configured to execute the instructions to select a better quality beam from the first beam and the second beam for decoding data signals based on the comparing of the signal quality characteristics. The at least one processor may further be configured to execute the instructions to decode a data signal of the better quality beam.

In another aspect, an apparatus for wireless communication is disclosed. The apparatus may include means for receiving a plurality of beams from a base station. The apparatus may also include means for determining payloads of a first control signal of a first beam of the plurality of beams and a second control signal of a second beam of the plurality of beams are a same payload. The apparatus may include means for comparing signal quality characteristics of the first control signal and the second control signal in response to the determining the payloads are the same payload. The apparatus may include means for selecting a better quality beam from the first beam and the second beam for decoding data signals based on the comparing of the signal quality characteristics. The apparatus may further include means for decoding a data signal of the better quality beam.

In another aspect, a non-transitory computer-readable medium storing computer code executable by a processor for wireless communications is disclosed. The computer-readable medium may include code to receive a plurality of beams from a base station. The computer-readable medium may include code to determine payloads of a first control signal of a first beam of the plurality of beams and a second control signal of a second beam of the plurality of beams are a same payload. The computer-readable medium may also include code to compare signal quality characteristics of the first control signal and the second control signal in response to the determining the payloads are the same payload. The computer-readable medium may include code to select a better quality beam from the first beam and the second beam for decoding data signals based on the comparing of the signal quality characteristics. The computer-readable medium may further include code to decode a data signal of the better quality beam.

In another aspect of the disclosure, a method for wireless communication by a base station is disclosed. The method may include transmitting a control signal, including a same payload, on each of a plurality of beams. The method may also include transmitting a data signal, including same data, on each of the plurality of beams based on the transmitting of the same payload on each of the plurality of beams.

In another aspect, an apparatus for wireless communication is disclosed. The apparatus may include a memory storing instructions and at least one processor coupled with the memory. The at least one processor may be configured to execute the instructions to transmit a control signal, including a same payload, on each of a plurality of beams. The at least one processor may be configured to execute the instructions to transmit a data signal, including same data, on each of the plurality of beams based on the transmitting of the same payload on each of the plurality of beams.

In another aspect, an apparatus for wireless communication is disclosed. The apparatus may include means for transmitting a control signal, including a same payload, on each of a plurality of beams. The apparatus may include means for transmitting a data signal, including same data, on each of the plurality of beams based on the transmitting of the same payload on each of the plurality of beams.

In another aspect, a non-transitory computer-readable medium storing computer code executable by a processor for wireless communications is disclosed. The computer-readable medium may include code to transmit a control signal, including a same payload, on each of a plurality of beams. The computer-readable medium may include code to transmit a data signal, including same data, on each of the plurality of beams based on the transmitting of the same payload on each of the plurality of beams.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a schematic diagram of an example wireless communications system;

FIG. 2 is a schematic diagram of an example of multiple beam transmission in a wireless communications system;

FIG. 3 is a schematic diagram another example of conceptual views of wireless communications;

FIG. 4 is a flowchart of an example method of wireless communications;

FIG. 5 is a schematic diagram of example components of a user equipment (UE) of FIG. 1;

FIG. 6 is a flowchart of another example method of wireless communications; and

FIG. 7 is a schematic diagram of example components of a base station of FIG. 1.

### DETAILED DESCRIPTION

This disclosure includes apparatus and methods to avoid reference signal (e.g. Demodulation Reference Signal (DMRS)) and data mismatch when control channels and the control-scheduled data channels are transmitted over multiple beams (e.g., multiple transmission configuration indicator (TCI) states).

In cases of transmitting downlink control information (DCI), when the parameter TCIpresentinDCI is disabled, the TCI state of a scheduling channel (e.g., physical downlink shared channel (PDSCH) is indicated by the TCI state of the corresponding control channel (e.g., the scheduling physical downlink control channel (PDCCH)). When PDCCHs are sent in different TCI states, or in other words, in different beams, then a decision by a user equipment (UE) of which PDSCH TCI beam to decode depends on which PDCCH it decodes. Since the base station (e.g., gNB) does not know which PDCCH the UE actually decodes, there exists ambiguity on which beam to send PDSCH.

While multiple solutions exist for avoiding this TCI state ambiguity, the described apparatus and methods provide a solution that may incur minimum signaling overhead. In particular, according to the present aspects, the base station transmits the same payload in a multi-beam PDCCH, and also transmits a corresponding number of multi-beam PDSCH resources. As such, the UE may determine which beam carries the PDCCH having best signal quality characteristics, and may utilize that beam with the best signal quality characteristics to receive and decode the PDSCH.

In some alternatives, to avoid potential power delay profile (PDP) mismatch, which could potentially degrade UE performance, the described apparatus and methods may further include the base station scrambling the PDSCH and/or the DMRS port as a function of the beam (e.g., TCI state). The present solution may further include cases where the same port or different ports are used for DMRS, and also cases where the base station performs TCI-state based scrambling on only data or on both DMRS and data.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

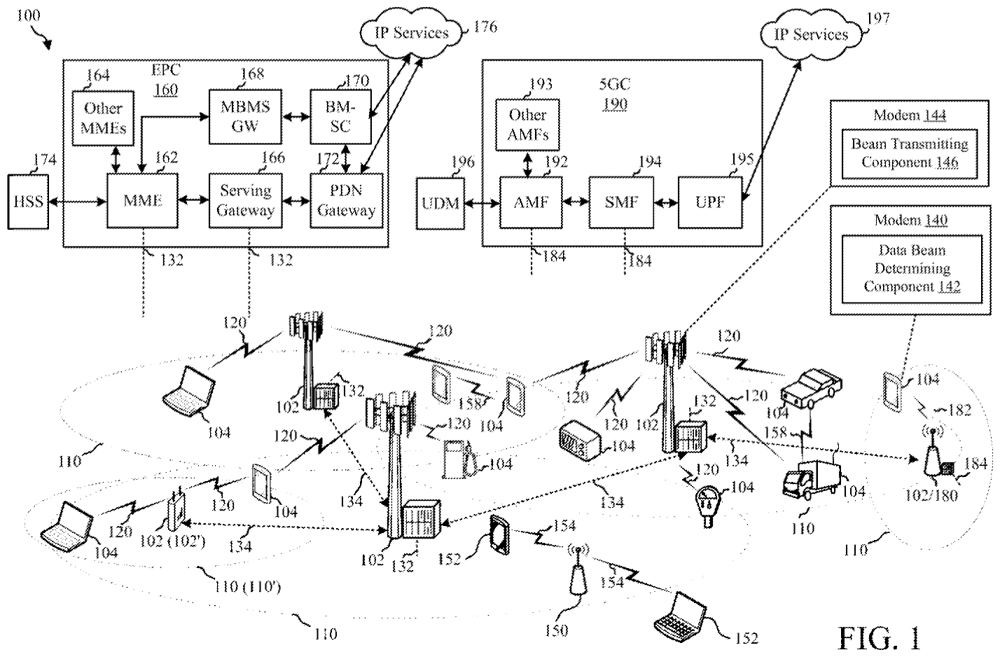

Referring to FIG. 1, an example of a wireless communications system 100 is illustrated. The wireless communications system 100 (also referred to as a wireless wide area network (WWAN)) includes one or more base stations 102 and one or more UEs 104.

In an aspect, the UE 104 may include one or more components, such as a modem 140 having a data beam determining component 142, that operate to determine which beam of multiple beams carrying control signals to use for decoding scheduled data when ambiguous or conflicting TCI state are indicated by each control signal. In particular, the data beam determining component 142 may be configured to receive a plurality of beams from a base station 102. The data beam determining component 142 may also be configured to determine payloads of a first control signal of a first beam of the plurality of beams and a second control signal of a second beam of the plurality of beams are a same payload. In an ambiguous or conflicting TCI state condition, the use of different beams having the same payload may be used to help the UE 104 pick a beam for decoding scheduled data, which avoids overhead, e.g., extra signaling. The data beam determining component 142 may further be configured to compare signal quality characteristics of the first control signal the second control signal in response to determining that the payloads are the same payload. The data beam determining component 142 may also be configured to select a better quality beam from the first beam and the second beam for decoding a data signal of the better quality beam based on the comparing of the signal quality characteristics. In some cases, the data beam determining component 142 may further be configured to decode the data signal of the better quality beam based on a scrambling sequence associated with the selected one of the first beam or the second beam. Further, in some cases, to reduce PDP mismatch, the data beam determining component 142 may also be configured to descramble the reference signal (e.g., DMRS), the data, or both in the data signal of the better quality beam based on the given scrambling sequence.

Correspondingly, in this scenario, the base stations 102 may include one or more components, such as a modem 144 having a beam transmitting component 146, that operate to provide the two or more beams with matching control signal payloads, and also a corresponding two or more beams with matching data signals to enable the UE 104 to receive transmitted data on a beam that is preferred by the UE 104. In particular, the beam transmitting component 146 may be configured to transmit a control signal, including a same payload, on each of a plurality of beams. The beam transmitting component 146 may further be configured to transmit a data signal, including same data, on each of the plurality of beams. The control signals with the same payload indicate to the UE 104 that it may use the beam with the best signal quality characteristic to decode the data signal. Further, in some cases to avoid PDP mismatch issues at the UE 104, the beam transmitting component 146 may be further configured to scramble DMRS, data, or both in the data signals according to a scrambling sequence specific to the beam on which the data signal is transmitted. In addition to the scrambling, in some cases, the beam transmitting component 146 may be further configured to transmit the data signals on the same port or on different ports (e.g., such that the pot is interpreted based on the TCI). In some cases, for example to minimize mismatch between DMRS and data associated with the received data signals at the UE 104, the beam transmitting component 146 may scramble the data, but not the DMRS, and may use different ports. In other cases, for example to minimize channel estimation error associated with the received data signals at the UE 104, the beam transmitting component 146 may scramble both the data and the DMRS, and may use the same ports.

The wireless communications system 100 may also include an Evolved Packet Core (EPC) 160, and a 5G Core (5GC) 190. The base stations 102 may include macro cells (high power cellular base station) and/or small cells (low power cellular base station). The macro cells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., S1 interface). The base stations 102 configured for 5G NR (collectively referred to as Next Generation RAN (NG-RAN)) may interface with 5GC 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or 5GC 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102.

A network that includes both small cell and macro cells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system 100 may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the wireless communications system 100.

A base station 102, whether a small cell 102′ or a large cell (e.g., macro base station), may include an evolved Node B (eNB), next generationg Node B (gNodeB or gNB), or other type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave (mmWave). Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 182 with the UE 104 to compensate for the extremely high path loss and short range.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting MBMS related charging information.

The 5GC 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the 5GC 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or 5GC 190 for a UE 104.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

As previously discussed, in mmWave technologies beams (also referred to as transmission configuration indicator (TCI) states) may be susceptible to blockages. Use of a plurality of beams may provide macro diversity for communications. However, transmission of the plurality of beams may cause mismatch between pilot signals, such as demodulation reference signals (DMRSs), and between data signals when control channels and control-scheduled data channels are transmitted over the multiple beams.

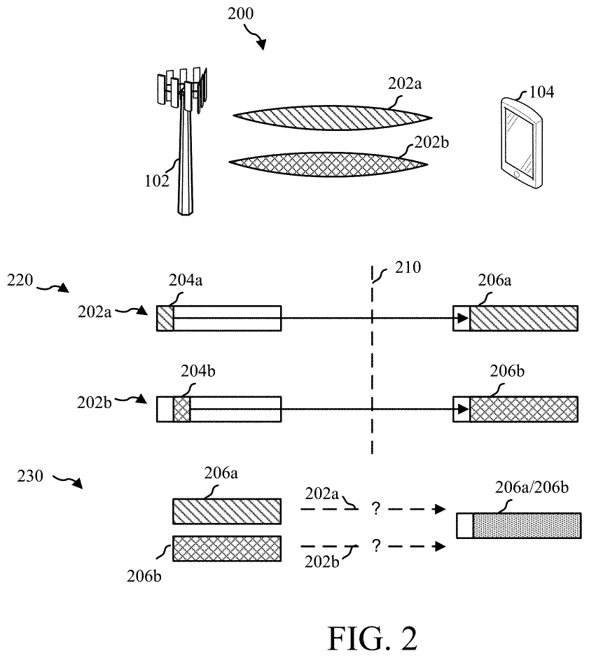

Referring to FIG. 2, in an example 200 of wireless communication using mmWaves technologies, the base station 102 and the UE 104 may communicate via a plurality of beams 202a, 202b. In some aspects, a beam (e.g., any of the beams 202a, 202b) for a data signal (i.e., physical DL shared channel (PDSCH)) may be indicated by a TCI of the scheduling control signal (i.e., physical DL control channel (PDCCH)). For example, in signal transmission diagram 220, the base station 102 may transmit the plurality of beams 202a, 202b having control signals 204a, 204b, respectively, and a TCI of the control signals 204a, 204b may indicate the data signals 206a, 206b of the respective beams 202a, 202b. As a default, if a data signal (e.g., PDSCH) is scheduled after a scheduling threshold 210, the data signal will use the same beam as the scheduling control signal (e.g., PSCCH). In the case of signal transmission diagram 220, however, if the control signals 204a, 204b of both beams 202a, 202b are transmitted before the scheduling threshold 210 (and, hence, the PDSCH is scheduled after the threshold), then the UE 104 will be in a TCI ambiguity condition where following the default rule indicates to the UE 104 to use both beam 204a and beam 204b for the data signal.

Similarly, in this condition, the base station 102 is in an ambiguous data signal transmission condition 230 because the base station 102 does not know which control signal the UE 104 actually decodes, and thus the base station 102 does not know which beam 202a or 202b to use to transmit the data signal.

In some examples, the UE 104 may signal back to the base station 102 on which beam the base station 102 should transmit the data signal. In some examples, the base station 104 may explicitly signal which beam 202a or 202b the UE 104 should use to receive and decode the data signal. However, signaling by the base station 102 and the UE 104 may cause additional signal overhead and potential signal collisions.

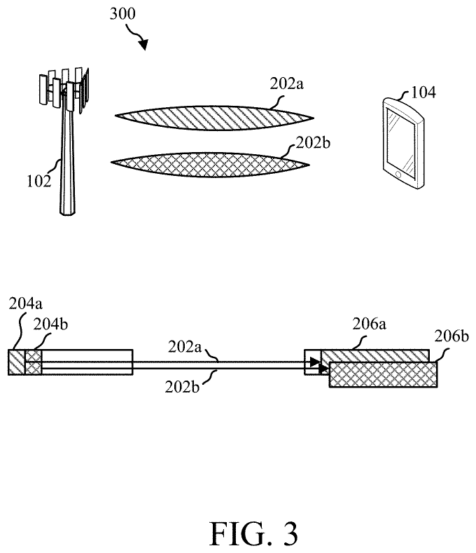

Referring to FIG. 3, according to the present aspects, one option for preventing the ambiguity, where no additional signaling is used, includes the signaling example 300 where the base station 102 transmits two or more control signals 204a and 204b, each in a different beam, e.g., beams 202a and 202b. Correspondingly, the base station 102 may then transmit two or more data signal resources (e.g., PDSCH resources), each having the same data, such that the UE 104 may decode a data signal from the beam determined by the UE 104 to have the best signal characteristics. For example, the base station 102 may transmit the control signals 204a, 204b on different beams 202a, 202b. The UE 104 may then decode the data signal (one of data signal 206a, 206b) based on which of the beams 202a 202b is better from a signal quality perspective. The UE 104 may determine which beam is better based on a comparison of one or more characteristics of the beams 202a, 202b. For example, the UE 104 may compare the characteristics of signal-to-noise ratio (SNR) values, block error (BLER) rates, or reference signal received power (RSRP) of the beams 202a, 202b to make a determination.

In some examples, while the above solution may eliminate additional signaling, in some cases the UE 104 may experience power delay profile (PDP) mismatch if the UE 104 only receives the data signal resources using a single layer. The PDP mismatch may create performance degradation for the UE 104. A pilot signal (e.g., the DMRS of a PDCCH-scheduled-PDSCH) may be quasi-co-located (QCL'ed) with a timing reference signal (TRS). In other words, to process the reference signal, covariance matrices of the channel may be precomputed based on QCL assumption. To avoid PDP mismatch, channel estimation with a reference signal is used for decoding a corresponding data signal. Because the channel estimation depends on the control signal from multiple beams, the channel estimation may be off due to delay spread and covariance estimates between TRS, DMRS, and PDSCH.

In some aspects, the base station 102 may transmit the same payload across control signals of multiple beams to counter signal blockage. Use of the same payload across control signals may trigger the UE 104 to select a beam that is best for decoding a data signal, as described. Using the same payload for triggering the UE 104 may limit signaling between the base station 102 and the UE 104, and may leverage macro diversity. In some examples, when the same payload is used, scrambling may not be performed on the data and reference signals and the same data and reference signal ports may be used.

In some aspects, the data signal ports and reference signal ports may be scrambled as a function of a beam to counter PDP mismatch. For example, when two or more beams (e.g., beams 202a, 202b) include the same payloads, the data signal may be scrambled and the reference signal may not be scrambled. In this example, the data signal and reference signal ports may be interpreted based on the which beam the UE 104 uses for decoding the control signal. In another example, both the data signal and the reference signal may be scrambled. When both data and reference signals are scrambled, both data and reference signal ports may be the same to minimize channel estimation error.

In some examples, the UE 104 may also combine a result of the decoding of a data signal (e.g., data signal 206a) of the better quality beam (e.g., beam 202a) and the decoding of the one or more additional data signals (e.g., data signal 202b) to obtain data.

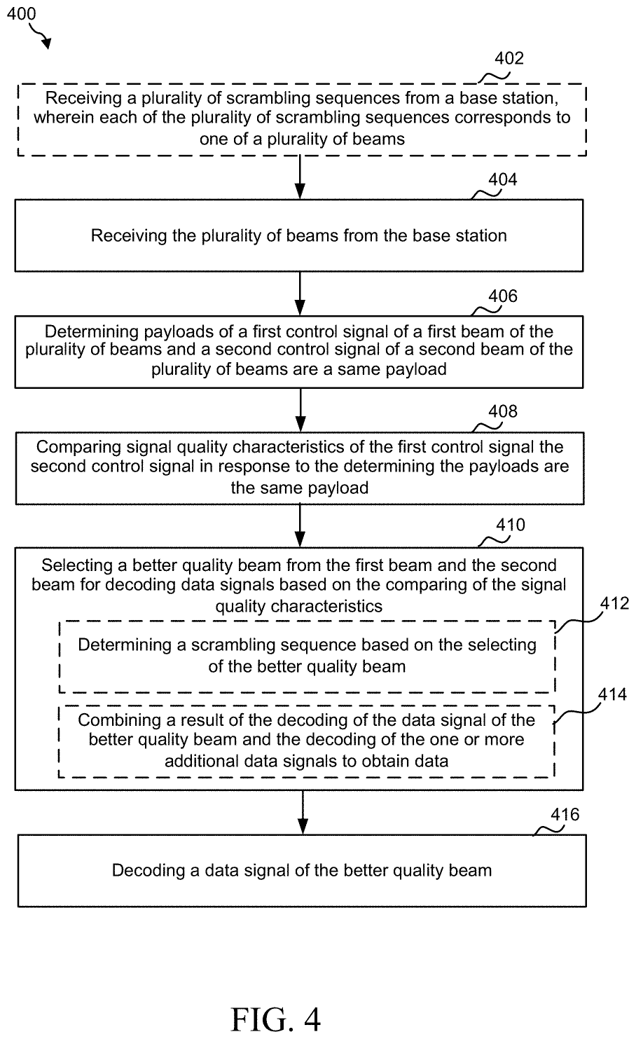

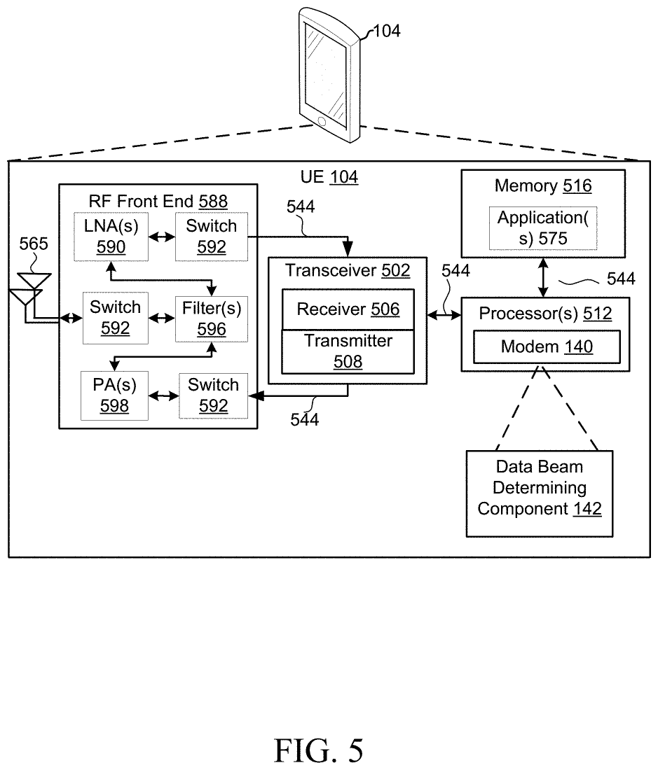

Referring to FIG. 4, an example of a method 400 of wireless communications may be performed by the UE 104 to enable beam specific scrambling of pilot and data signals. Aspects of the method 400 may be performed by the UE 104 of FIG. 1 and/or by one or more components of the UE 104 of FIG. 5, including but not limited to processors 512, the modem 140, a transceiver 502, a memory 516, a radio frequency (RF) front end 588, and/or the data beam determining component 142. In some examples, the data beam determining component 142 may include one or more subcomponents that are configured to perform specific functions, actions, or processes associated with the method 400.

At block 402, the method 400 may optionally include receiving a plurality of scrambling sequences from a base station, wherein each of the plurality of scrambling sequences corresponds to one of a plurality of beams. For example, one or more components (e.g., the processors 512, the modem 140, the transceiver 502, the radio frequency (RF) front end 588, and/or the data beam determining component 142) of the UE 104 may receive a plurality of scrambling sequences from the base station 102, wherein each of the plurality of scrambling sequences corresponds to one of a plurality of beams 202a, 202b.

At block 404, the method 400 may also include receiving a plurality of beams from the base station. As an example, one or more components (e.g., the processors 512, the modem 140, the transceiver 502, the radio frequency (RF) front end 588, and/or the data beam determining component 142) of the UE 104 may receive the beams 202a, 202b from the base station 102.

At block 406, the method 400 may include determining payloads of a first control signal of a first beam of the plurality of beams and a second control signal of a second beam of the plurality of beams are a same payload. For example, one or more components (e.g., the processors 512 and/or the data beam determining component 142) of the UE 104 may determine payloads of the control signal 204a of the beam 202a and the control signal 204b of the beam 204a are a same payload. In an example, the UE 104 may compare payloads of each of the plurality of beams to determine which beams of the plurality of beams contain a same payload. In some examples, control signals with the same payload may indicate to the UE 104 that the UE 104 may use a beam with the best signal quality characteristic to decode a corresponding data signal.

At block 408, the method 400 may further include comparing signal quality characteristics of the first control signal the second control signal in response to the determining the payloads are the same payload. For example, one or more components (e.g., the processors 512 and/or the data beam determining component 142) of the UE 104 may compare signal quality characteristics of the control signals 204a, 204b in response to the determining the payloads of the beams 202a, 202b include the same payload. In some examples, the signal quality characteristics may include one or more of signal-to-noise ratio (SNR) values, block error (BLER) rates, or reference signal received power (RSRP).

At block 410, the method 400 may also include selecting a better quality beam from the first beam and the second beam for decoding data signals based on the comparing of the signal quality characteristics. For example, one or more components (e.g., the processors 512 and/or the data beam determining component 142) of the UE 104 may select a better quality beam from the beams 202a, 202b for decoding data signals based on the comparing of the signal quality characteristics.

At block 412, the method 400 may optionally include determining a scrambling sequence based on the selecting of the better quality beam. For example, one or more components (e.g., the processors 512 and/or the data beam determining component 142) of the UE 104 may determine a scrambling sequence based on the selecting of the better quality beam (e.g., one of the beams 202a or 22b).

In some aspects, the determining of the scrambling sequence may include identifying the scrambling sequence corresponding to the better quality beam from among the plurality of scrambling sequences.

At block 414, the method 400 may optionally include combining a result of the decoding of the data signal of the better quality beam and the decoding of the one or more additional data signals to obtain data. For example, one or more components (e.g., the processors 512 and/or the data beam determining component 142) of the UE 104 may combine a result of the decoding of the data signal (e.g., data signal 206a) of the better quality beam and the decoding of the one or more additional data signals (e.g., data signal 206b) to obtain data.

At block 416, the method 400 may further include decoding a data signal of the better quality beam. For example, one or more components of the UE 104 may decode one or the data signals 206a or 206b depending on which one of the corresponding beams is the better quality beam.

In some aspects, the decoding of the data signal of the better quality beam may further comprise decoding using the scrambling sequence.

In some aspects, the decoding of the data signal of the better quality beam may further comprise decoding a reference signal, data, or both using the scrambling sequence.

In some aspects, the method 400 may further include determining one or more sets of additional payloads of one or more sets of additional control signals of one or more additional sets of the plurality of beams, in addition to the first beam and the second beam, are the same payload.

In some aspects, the method 400 may also include comparing the signal quality characteristics of the one or more sets of additional control signals in response to the determining of the same payload.

In some aspects, the method 400 may further include selecting a set of one or more additional better quality beams from the one or more additional sets of the plurality of beams for decoding one or more additional data signals based on the comparing of the signal quality characteristics of the one or more sets of additional control signals.

In some aspects, the method 400 may also include decoding the one or more additional data signals of the set of one or more additional better quality beams.

In some aspects, the first control signal of the first beam and the second control signal of the second beam occur before a scheduling threshold for scheduling the data signals on each of the first beam and the second beam. In some aspects, the first control signal of the first beam and the second control signal of the second beam each control a TCI state of the data signals.

Referring to FIG. 5, example hardware components and subcomponents of a wireless communications device (e.g., UE 104) for implementing the techniques for beam determination in TCI ambiguity scenarios is provided by this disclosure. For example, one implementation of the wireless communications device may include a variety of components, including components such as the processors 512, the memory 516, the transceiver 502, and the modem 140 in communication via one or more buses 544, which may operate in conjunction with the data beam determining component 142 to enable one or more of the functions described herein as well as one or more methods (e.g., method 400) of the present disclosure. For example, the one or more processors 512, the memory 516, the transceiver 502, and/or the modem 140 may be communicatively coupled via the one or more buses 544. Further, the one or more processors 512, the modem 140, the memory 516, the transceiver 502, as well the RF front end 588, may be configured to support resource configuring operations.

In an aspect, the one or more processors 516 may include the modem 140 that may use one or more modem processors. The various functions related to the data beam determining component 142 may be included in the modem 140 and/or the one or more processors 512 and, in an aspect, can be executed by a single processor, while in other aspects, different ones of the functions may be executed by a combination of two or more different processors. For example, in an aspect, the one or more processors 512 may include any one or any combination of a modem processor, or a baseband processor, or a digital signal processor, or a transmit processor, or a receiver processor, or a transceiver processor associated with the transceiver 502. In other aspects, some of the features of the one or more processors 512 and/or the modem 140 associated with the data beam determining component 142 may be performed by the transceiver 502.

Also, the memory 516 may be configured to store data used herein and/or local versions of applications or the data beam determining component 142 and/or one or more of its subcomponents being executed by at least one processor 512. The memory 516 can include any type of computer-readable medium usable by a computer or at least one processor 512, such as random access memory (RAM), read only memory (ROM), tapes, magnetic discs, optical discs, volatile memory, non-volatile memory, and any combination thereof. In an aspect, for example, the memory 516 may be a non-transitory computer-readable storage medium that stores one or more computer-executable codes defining the resource configuration component 155 and/or one or more of its subcomponents, and/or data associated therewith, when the wireless communications device is operating at least the processors 512 to execute the data beam determining component 142 and/or one or more of its subcomponents.

The transceiver 502 may include at least one receiver 506 and at least one transmitter 508. The receiver 506 may include hardware, firmware, and/or software code executable by a processor for receiving data, the code comprising instructions and being stored in a memory (e.g., computer-readable medium). The receiver 506 may be, for example, an RF receiver. In an aspect, the receiver 506 may receive signals transmitted by at least one wireless communications device (e.g., base station 102). Additionally, the receiver 506 may process such received signals, and also may obtain measurements of the signals, such as, but not limited to, Ec/Io, SNR, RSRP, RSSI, etc. The transmitter 508 may include hardware, firmware, and/or software code executable by a processor for transmitting data, the code comprising instructions and being stored in a memory (e.g., computer-readable medium). A suitable example of the transmitter 508 may include, but is not limited to, an RF transmitter.

Moreover, in an aspect, the wireless communications device may include the RF front end 588 mentioned above, which may operate in communication with one or more antennas 565 and the transceiver 502 for receiving and transmitting radio transmissions. In an example, an antenna may include or more antennas, antenna elements, and/or antenna arrays. The RF front end 588 may be connected to the one or more antennas 565 and can include one or more low-noise amplifiers (LNAs) 590, one or more switches 592, one or more power amplifiers (PAs) 598, and one or more filters 596 for transmitting and receiving RF signals.

In an aspect, the LNA 590 can amplify a received signal at a desired output level. In an aspect, each LNA 590 may have a specified minimum and maximum gain values. In an aspect, the RF front end 588 may use the one or more switches 592 to select a particular LNA 590 and its specified gain value based on a desired gain value for a particular application.

Further, for example, the one or more PA(s) 598 may be used by the RF front end 588 to amplify a signal for an RF output at a desired output power level. In an aspect, each PA 598 may have specified minimum and maximum gain values. In an aspect, the RF front end 588 may use the one or more switches 592 to select a particular PA 598 and its specified gain value based on a desired gain value for a particular application.

Also, for example, the one or more filters 596 may be used by the RF front end 588 to filter a received signal to obtain an input RF signal. Similarly, in an aspect, for example, a respective filter 596 can be used to filter an output from a respective PA 598 to produce an output signal for transmission. In an aspect, each filter 596 can be connected to a specific LNA 590 and/or PA 598. In an aspect, the RF front end 588 can use one or more switches 592 to select a transmit or receive path using a specified filter 596, LNA 590, and/or PA 598, based on a configuration as specified by the transceiver 502 and/or the one or more processors 512.

As such, the transceiver 502 may be configured to transmit and receive wireless signals through the one or more antennas 565 via the RF front end 588. In an aspect, the transceiver 502 may be tuned to operate at specified frequencies. In an aspect, for example, the modem 140 can configure the transceiver 502 to operate at a specified frequency and power level based on the configuration of the wireless communications device or UE 104 and the communication protocol used by the modem 140.

In an aspect, the modem 140 can be a multiband-multimode modem, which can process digital data and communicate with the transceiver 502 such that the digital data is sent and received using the transceiver 502. In an aspect, the modem 140 can be multiband and be configured to support multiple frequency bands for a specific communications protocol. In an aspect, the modem 140 can be multimode and be configured to support multiple operating networks and communications protocols. In an aspect, the modem 140 can control one or more components of the wireless communications device (e.g., the RF front end 588, the transceiver 502) to enable transmission and/or reception of signals based on a specified modem configuration. In an aspect, the modem configuration may be based on the mode of the modem and the frequency band in use. In another aspect, the modem configuration may be based on UE configuration information associated with the wireless communications device.

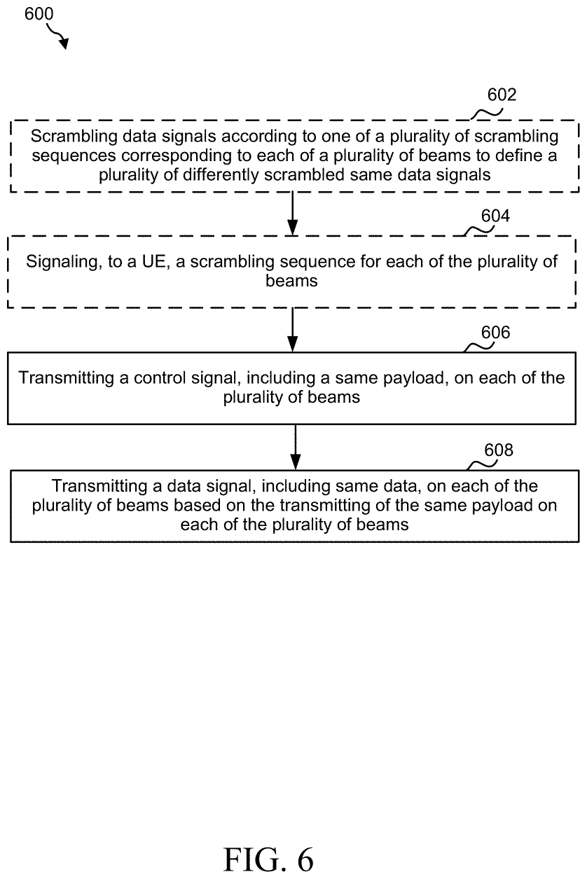

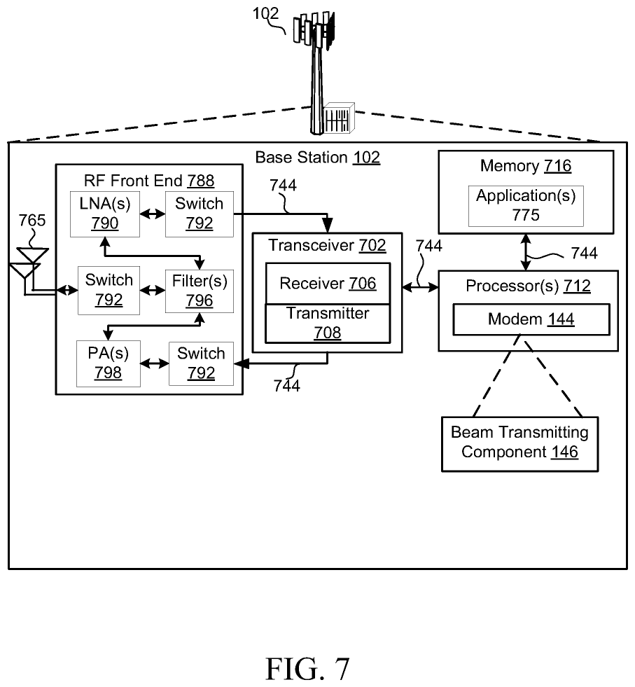

Referring to FIG. 6, an example of a method 600 of wireless communications may be performed by the base station 102 to enable multi-beam transmission of data and reference signals as described herein. Aspects of the method 600 may be performed by the base station 102 of FIG. 1, and/or by one or more components of the base station 102 of FIG. 7, including but not limited to processors 712, the modem 144, a transceiver 702, a memory 716, a radio frequency (RF) front end 788, and/or the beam transmitting component 146. In some examples, the beam transmitting component 146 may include one or more subcomponents that are configured to perform specific functions, actions, or processes associated with the method 600.

At block 602, the method 600 may optionally include scrambling data signals according to one of a plurality of scrambling sequences corresponding to each of a plurality of beams to define a plurality of differently scrambled same data signals. For example, one or more components of the base station 102 may scramble the data signals 206a, 206b. In some examples, the scrambling of each of the data signals further comprises scrambling a reference signal, data, or both using each of a plurality of scrambling sequences. For example, the base station 102 may scramble a reference signal, data signal, or both using each of a plurality of scrambling sequences.

At block 604, the method 600 may optionally include signaling, to a user equipment (UE), a scrambling sequence for each of the plurality of beams. For example, one or more components of the base station 102 may signal, to the UE 104, a scrambling sequence for each of the beams 202a, 202b.

At block 606, the method 600 may include transmitting a control signal, including a same payload, on each of the plurality of beams. For example, one or more components of the base station 102 may transmit a control signal (e.g., control signal 204a or 204b), including a same payload, on each of a plurality of beams 202a, 202b.

At block 608, the method 600 may include transmitting a data signal, including same data, on each of the plurality of beams based on the transmitting of the same payload on each of the plurality of beams. For example, one or more components of the base station 102 may transmit a data signal (e.g., data signals 206a or 206b), including same data, on each of the plurality of beams 202a, 202b based on the transmitting of the same payload on each of the plurality of beams 202a, 202b.

In some examples, the differently scrambled data signals 206a, 206b may be transmitted on corresponding beams 202a, 202b. In some examples, the transmitting of the data signals 206a, 206b on each of the plurality of beams 202a, 202b may include transmitting using a same port or transmitting using different ports.

In some examples, each control signal 204a, 204b of each of the plurality of beams 202a, 202b may occur before a scheduling threshold 210 for scheduling data signals 204a, 204b on each of the plurality of beams 202a, 202b. In some examples, each control signal 204a, 204b of each of the plurality of beams 202a, 202b controls a TCI state of the same data signals.

FIG. 7 describes hardware components and subcomponents of the base station 102 for implementing the techniques for beam specific scrambling of pilot and data signals provided by this disclosure. The base station 102 may include the processors 712, the memory 716, the modem 144, and the transceiver 702, which may communicate between them using a bus 744. For example, the one or more processors 712, the memory 716, the transceiver 702, and/or the modem 144 may be communicatively coupled via the one or more buses 744. The transceiver 702 may include a receiver 706 and a transmitter 708. Moreover, the base station 102 may include the RF front end 788 and one or more antennas 765, where the RF front end 788 may include LNA(s) 790, switches 792, filters 796, and PA(s) 798. Each of these components or subcomponents of the STA 115 may operate in a similar manner as the corresponding components described above in connection with the wireless communications device of FIG. 5.

The one or more processors 712, the memory 716, the transceiver 702, and the modem 144 may operate in conjunction with the beam transmitting component 146 to enable one or more of the functions described herein in connection with a base station for beam specific scrambling of pilot and data signals.

### Some Further Example Implementations

An example method of wireless communication by a user equipment (UE), comprising: receiving a plurality of beams from a base station; determining payloads of a first control signal of a first beam of the plurality of beams and a second control signal of a second beam of the plurality of beams are a same payload; comparing signal quality characteristics of the first control signal and the second control signal in response to the determining the payloads are the same payload; selecting a better quality beam from the first beam and the second beam for decoding data signals based on the comparing of the signal quality characteristics; and decoding a data signal of the better quality beam.

The above example method, wherein the signal quality characteristics include one or more of signal-to-noise ratio (SNR) values, block error (BLER) rates, or reference signal received power (RSRP).

One or more of the above example methods, further comprising: determining a scrambling sequence based on the selecting of the better quality beam; and wherein the decoding of the data signal of the better quality beam further comprises decoding using the scrambling sequence.

One or more of the above example methods, further comprising: receiving a plurality of scrambling sequences from the base station, wherein each of the plurality of scrambling sequences corresponds to one of the plurality of beams; and wherein the determining of the scrambling sequence comprises identifying the scrambling sequence corresponding to the better quality beam from among the plurality of scrambling sequences.

One or more of the above example methods, wherein the decoding of the data signal of the better quality beam further comprises decoding a reference signal, data, or both using the scrambling sequence.

One or more of the above example methods, further comprising: determining one or more sets of additional payloads of one or more sets of additional control signals of one or more additional sets of the plurality of beams, in addition to the first beam and the second beam, are the same payload; comparing the signal quality characteristics of the one or more sets of additional control signals in response to the determining of the same payload; selecting a set of one or more additional better quality beams from the one or more additional sets of the plurality of beams for decoding one or more additional data signals based on the comparing of the signal quality characteristics of the one or more sets of additional control signals; and decoding the one or more additional data signals of the set of one or more additional better quality beams.

One or more of the above example methods, further comprising: combining a result of the decoding of the data signal of the better quality beam and the decoding of the one or more additional data signals to obtain data.

One or more of the above example methods, wherein the first control signal of the first beam and the second control signal of the second beam occur before a scheduling threshold for scheduling the data signals on each of the first beam and the second beam.

One or more of the above example methods, wherein the first control signal of the first beam and the second control signal of the second beam each control a transmission configuration indicator (TCI) state of the data signals.

A second example method of wireless communication by a base station, comprising: transmitting a control signal, including a same payload, on each of a plurality of beams; and transmitting a data signal, including same data, on each of the plurality of beams based on the transmitting of the same payload on each of the plurality of beams.

The above second example method, further comprising: scrambling each of the data signals according to one of a plurality of scrambling sequences corresponding to each of the plurality of beams to define a plurality of differently scrambled same data signals; and wherein the transmitting of the data signals on each of the plurality of beams further comprises transmitting each of the plurality of differently scrambled same data signals on a corresponding one of the plurality of beams.

One or more of the above second example methods, wherein the scrambling of each of the data signals further comprises scrambling a reference signal, data, or both using each of a plurality of scrambling sequences.

One or more of the above second example methods, wherein the transmitting of the data signals on each of the plurality of beams comprises transmitting using a same port or transmitting using different ports.

One or more of the above second example methods, further comprising: signaling, to a user equipment (UE), a scrambling sequence for each of the plurality of beams.

One or more of the above second example methods, wherein each control signal of each of the plurality of beams occurs before a scheduling threshold for scheduling data signals on each of the plurality of beams.

One or more of the above second example methods, wherein each control signal of each of the plurality of beams controls a transmission configuration indicator (TCI) state of the same data signals.

An example apparatus (e.g., UE) for wireless communication, comprising: a memory storing instructions; and at least one processor coupled with the memory and configured to execute the instructions to: receive a plurality of beams from a base station; determine payloads of a first control signal of a first beam of the plurality of beams and a second control signal of a second beam of the plurality of beams are a same payload; compare signal quality characteristics of the first control signal and the second control signal in response to the determining the payloads are the same payload; select a better quality beam from the first beam and the second beam for decoding data signals based on the comparing of the signal quality characteristics; and decode a data signal of the better quality beam.

The above example apparatus, wherein the signal quality characteristics include one or more of signal-to-noise ratio (SNR) values, block error (BLER) rates, or reference signal received power (RSRP).

One or more of the above example apparatus, wherein the at least one processor is further configured to execute the instructions to: determine a scrambling sequence based on the selecting of the better quality beam; and decode the data signal of the better quality beam using the scrambling sequence.

One or more of the above example apparatus, wherein the at least one processor is further configured to execute the instructions to: receive a plurality of scrambling sequences from the base station, wherein each of the plurality of scrambling sequences corresponds to one of the plurality of beams; and identify the scrambling sequence corresponding to the better quality beam from among the plurality of scrambling sequences.

One or more of the above example apparatus, wherein the at least one processor is further configured to execute the instructions to: decode a reference signal, data, or both using the scrambling sequence.

One or more of the above example apparatus, wherein the at least one processor is further configured to execute the instructions to: determine one or more sets of additional payloads of one or more sets of additional control signals of one or more additional sets of the plurality of beams, in addition to the first beam and the second beam, are the same payload; compare the signal quality characteristics of the one or more sets of additional control signals in response to the determining of the same payload; select a set of one or more additional better quality beams from the one or more additional sets of the plurality of beams for decoding one or more additional data signals based on the comparing of the signal quality characteristics of the one or more sets of additional control signals; and decode the one or more additional data signals of the set of one or more additional better quality beams.

One or more of the above example apparatus, wherein the at least one processor is further configured to execute the instructions to: combine a result of the decoding of the data signal of the better quality beam and the decoding of the one or more additional data signals to obtain data.

One or more of the above example apparatus, wherein the first control signal of the first beam and the second control signal of the second beam occur before a scheduling threshold for scheduling the data signals on each of the first beam and the second beam.

A second example apparatus (e.g., base station) for wireless communication, comprising: a memory; and at least one processor coupled with the memory and configured to execute the instructions to: transmit a control signal, including a same payload, on each of a plurality of beams; and transmit a data signal, including same data, on each of the plurality of beams based on the transmitting of the same payload on each of the plurality of beams.

The above second example apparatus, wherein the at least one processor is further configured to: scramble each of the data signals according to one of a plurality of scrambling sequences corresponding to each of the plurality of beams to define a plurality of differently scrambled same data signals; and transmit each of the plurality of differently scrambled same data signals on a corresponding one of the plurality of beams.

One or more of the above second example apparatus, wherein the at least one processor is further configured to execute the instructions to: scramble a reference signal, data, or both using each of a plurality of scrambling sequences.

One or more of the above second example apparatus, wherein the at least one processor is further configured to execute the instructions to: transmit the data signals on each of the plurality of beams using a same port or using different ports.

One or more of the above second example apparatus, wherein the at least one processor is further configured to execute the instructions to: signal, to a user equipment (UE), a scrambling sequence for each of the plurality of beams.

One or more of the above second example apparatus, wherein each control signal of each of the plurality of beams occurs before a scheduling threshold for scheduling data signals on each of the plurality of beams.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof

The various illustrative blocks and components described in connection with the disclosure herein may be implemented or performed with a specially-programmed device, such as but not limited to a processor, a digital signal processor (DSP), an ASIC, a FPGA or other programmable logic device, a discrete gate or transistor logic, a discrete hardware component, or any combination thereof designed to perform the functions described herein. A specially-programmed processor may be a microprocessor, but in the alternative, the processor may be any conventional processor, controller, microcontroller, or state machine. A specially-programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above can be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

Moreover, nothing disclosed herein is intended to be dedicated to the public regardless of whether such disclosure is explicitly recited in the claims. No claim element is to be construed under the provisions of 35 U.S.C. § 112 (0, unless the element is expressly recited using the phrase “means for” or, in the case of a method claim, the element is recited using the phrase “step for.”

What is claimed is:

1. A method of wireless communication by a user equipment (UE), comprising:
receiving a plurality of beams from a base station;
determining payloads of a first control signal of a first beam of the plurality of beams and a second control signal of a second beam of the plurality of beams are a same payload;
comparing signal quality characteristics of the first control signal and the second control signal in response to the determining the payloads are the same payload;
selecting a better quality beam from the first beam and the second beam for decoding data signals based on the comparing of the signal quality characteristics; and
decoding a data signal of the better quality beam.

2. The method of claim 1, wherein the signal quality characteristics include one or more of signal-to-noise ratio (SNR) values, block error (BLER) rates, or reference signal received power (RSRP).

3. The method of claim 1, further comprising:
determining a scrambling sequence based on the selecting of the better quality beam; and
wherein the decoding of the data signal of the better quality beam further comprises decoding using the scrambling sequence.

4. The method of claim 3, further comprising:
receiving a plurality of scrambling sequences from the base station, wherein each of the plurality of scrambling sequences corresponds to one of the plurality of beams; and
wherein the determining of the scrambling sequence comprises identifying the scrambling sequence corresponding to the better quality beam from among the plurality of scrambling sequences.

5. The method of claim 3, wherein the decoding of the data signal of the better quality beam further comprises decoding a reference signal, data, or both using the scrambling sequence.

6. The method of claim 1, further comprising:
determining one or more sets of additional payloads of one or more sets of additional control signals of one or more additional sets of the plurality of beams, in addition to the first beam and the second beam, are the same payload;
comparing the signal quality characteristics of the one or more sets of additional control signals in response to the determining of the same payload;
selecting a set of one or more additional better quality beams from the one or more additional sets of the plurality of beams for decoding one or more additional data signals based on the comparing of the signal quality characteristics of the one or more sets of additional control signals; and
decoding the one or more additional data signals of the set of one or more additional better quality beams.

7. The method of claim 6, further comprising:
combining a result of the decoding of the data signal of the better quality beam and the decoding of the one or more additional data signals to obtain data.

8. The method of claim 1, wherein the first control signal of the first beam and the second control signal of the second beam occur before a scheduling threshold for scheduling the data signals on each of the first beam and the second beam.

9. The method of claim 1, wherein the first control signal of the first beam and the second control signal of the second beam each control a transmission configuration indicator (TCI) state of the data signals.

10. A method of wireless communication by a base station, comprising:
transmitting a control signal, including a same payload, on each of a plurality of beams; and
transmitting a data signal, including same data, on each of the plurality of beams based on the transmitting of the same payload on each of the plurality of beams.

11. The method of claim 10, further comprising:
scrambling each of the data signals according to one of a plurality of scrambling sequences corresponding to each of the plurality of beams to define a plurality of differently scrambled same data signals; and
wherein the transmitting of the data signals on each of the plurality of beams further comprises transmitting each of the plurality of differently scrambled same data signals on a corresponding one of the plurality of beams.

12. The method of claim 11, wherein the scrambling of each of the data signals further comprises scrambling a reference signal, data, or both using each of a plurality of scrambling sequences.

13. The method of claim 10, wherein the transmitting of the data signals on each of the plurality of beams comprises transmitting using a same port or transmitting using different ports.

14. The method of claim 10, further comprising:
signaling, to a user equipment (UE), a scrambling sequence for each of the plurality of beams.

15. The method of claim 10, wherein each control signal of each of the plurality of beams occurs before a scheduling threshold for scheduling data signals on each of the plurality of beams.

16. The method of claim 10, wherein each control signal of each of the plurality of beams controls a transmission configuration indicator (TCI) state of the same data signals.

17. An apparatus for wireless communication, comprising:
a memory storing instructions; and
at least one processor coupled with the memory and configured to execute the instructions to:
receive a plurality of beams from a base station;
determine payloads of a first control signal of a first beam of the plurality of beams and a second control signal of a second beam of the plurality of beams are a same payload;
compare signal quality characteristics of the first control signal and the second control signal in response to the determining the payloads are the same payload;
select a better quality beam from the first beam and the second beam for decoding data signals based on the comparing of the signal quality characteristics; and
decode a data signal of the better quality beam.

18. The apparatus of claim 17, wherein the signal quality characteristics include one or more of signal-to-noise ratio (SNR) values, block error (BLER) rates, or reference signal received power (RSRP).

19. The apparatus of claim 17, wherein the at least one processor is further configured to execute the instructions to:
determine a scrambling sequence based on the selecting of the better quality beam; and
decode the data signal of the better quality beam using the scrambling sequence.

20. The apparatus of claim 19, wherein the at least one processor is further configured to execute the instructions to:
receive a plurality of scrambling sequences from the base station, wherein each of the plurality of scrambling sequences corresponds to one of the plurality of beams; and
identify the scrambling sequence corresponding to the better quality beam from among the plurality of scrambling sequences.

21. The apparatus of claim 19, wherein the at least one processor is further configured to execute the instructions to:
decode a reference signal, data, or both using the scrambling sequence.

22. The apparatus of claim 17, wherein the at least one processor is further configured to execute the instructions to:
determine one or more sets of additional payloads of one or more sets of additional control signals of one or more additional sets of the plurality of beams, in addition to the first beam and the second beam, are the same payload;
compare the signal quality characteristics of the one or more sets of additional control signals in response to the determining of the same payload;
select a set of one or more additional better quality beams from the one or more additional sets of the plurality of beams for decoding one or more additional data signals based on the comparing of the signal quality characteristics of the one or more sets of additional control signals; and
decode the one or more additional data signals of the set of one or more additional better quality beams.

23. The apparatus of claim 22, wherein the at least one processor is further configured to execute the instructions to:
combine a result of the decoding of the data signal of the better quality beam and the decoding of the one or more additional data signals to obtain data.

24. The apparatus of claim 17, wherein the first control signal of the first beam and the second control signal of the second beam occur before a scheduling threshold for scheduling the data signals on each of the first beam and the second beam.

25. An apparatus for wireless communication, comprising:
a memory; and
at least one processor coupled with the memory and configured to execute the instructions to:
transmit a control signal, including a same payload, on each of a plurality of beams; and
transmit a data signal, including same data, on each of the plurality of beams based on the transmitting of the same payload on each of the plurality of beams.

26. The apparatus of claim 25, wherein the at least one processor is further configured to:
scramble each of the data signals according to one of a plurality of scrambling sequences corresponding to each of the plurality of beams to define a plurality of differently scrambled same data signals; and
transmit each of the plurality of differently scrambled same data signals on a corresponding one of the plurality of beams.

27. The apparatus of claim 26, wherein the at least one processor is further configured to execute the instructions to:
scramble a reference signal, data, or both using each of a plurality of scrambling sequences.

28. The apparatus of claim 25, wherein the at least one processor is further configured to execute the instructions to:
transmit the data signals on each of the plurality of beams using a same port or using different ports.

29. The apparatus of claim 25, wherein the at least one processor is further configured to execute the instructions to:
signal, to a user equipment (UE), a scrambling sequence for each of the plurality of beams.

30. The apparatus of claim 25, wherein each control signal of each of the plurality of beams occurs before a scheduling threshold for scheduling data signals on each of the plurality of beams.
